(19) United States
(12) Patent Application Publication
(10) Pub. No.: US 2003/0132813 A1
(43) Pub. Date: Jul. 17, 2003

(54) Attenuator having a coupling section and a plurality of resistors

(76) Inventors: Martin T. Gottschalk, Stuart, FL (US); Michael J. Kettner, Stuart, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/043,807

(22) Filed: Jan. 11, 2002

(51) Int. Cl. H01P 1/22

(52) U.S. Cl. 333/81 A; 333/81 R

(57) ABSTRACT

An attenuator is provided which includes a first conductive path having a coupling section and configured to receive a signal. The attenuator further provides a coupling section configured to attenuate the signal to produce an attenuated signal and positioned adjacent to the coupled line section of the first conductive path. A second conductive path is also provided having a coupled line section positioned adjacent to the coupling section and configured to transmit the attenuated signal. A first resistor is connected to the first conductive path and configured to dissipate power from the signal and to provide termination at the system's characteristic impedance. A second resistor is connected to the second conductive path and configured to dissipate power from the attenuated signal and to provide termination at the system's characteristic impedance.

### BACKGROUND OF THE INVENTION

1. Field of the Invention

The present invention relates generally to an attenuator and, more particularly, to an attenuator having a coupling section and a plurality of resistors.

2. Description of the Related Art

An attenuator is a device used in electrical circuits to reduce the level of a signal. For example, an attenuator might be used in an amplification system to control the level of the signal to be amplified and/or the amount of signal feedback. The most basic type of attenuator is a resistance attenuator, which typically utilizes three resistors connected in series and shunt across a signal source. Resistance attenuators are typically used in filters, isolators, and termination circuits. FIGS. 1 and 2 illustrate variations of the basic resistance attenuator.

FIG. 1 is a schematic diagram of a prior art resistance “Pi” attenuator. The Pi attenuator utilizes three resistors, R₁, R₂ and R₃. The value of resistor R₁ is equal to the value of resistor R₂ and Zᵢₙ=Zₒᵤₜ. In addition, R₁=Zᵢₙ(sqrt(N)+1)/(sqrt(N)−1) and R₃=Z_{L}(N−1)/2sqrt(N), where N=log⁻¹(dB/10).

FIG. 2 is a schematic diagram of a prior art resistance “T” attenuator. The T attenuator also utilizes three resistors, R₁, R₂ and R₃. The value of resistor R₁ is equal to the value of resistor R₂ and Zᵢₙ=Zₒᵤₜ. In addition, R₁=Zᵢₙ(sqrt(N)−1)/(sqrt(N)+1) and R₃=2Z_{L}(sqrt(N))/(N−1), where N=log⁻¹(dB/10). For high power radio frequency (“RF”) applications, the most common attenuator construction technique is to form the resistors on a thermally conductive ceramic substrate.

Typically RF attenuators are manufactured on a dielectric substrate either by a resistive metal deposition or resistive ink printing process. To keep the manufacturing process simple and cost effective, all of the attenuator resistors have the same surface resistivity, and the resistance value of each resistor on the circuit is determined by the resistors' width and length. For example, a 53 ohm resistor may be obtained by depositing 70 ohm/square unit metalization in an area that is 50 mils long and 70.75 mils wide (R=Rₛ*(length/width), where Rₛ is the surface resistivity). After the metal deposition or printing process, each resistor is calibrated either by hand, machine, or a laser for exact resistance.

One drawback of the resistance attenuators is that when the resistors are formed on a ceramic substrate, resistance imbalances occur. A resistance imbalance occurs when the value of the shunt resistor is much different than the value of the in-line resistor. For example, if the Pi attenuator is to achieve a 30 dB attenuation for a 50 ohm characteristic impedance system, a 53 ohm shunt resistor R1 combined with a 790 ohm in-line resistor R3 will result in a resistance imbalance. The resistance imbalance occurs because the geometry of the 53 ohm shunt resistor is much different than the geometry of the 790 ohm in-line resistor for a given surface resistivity, i.e., width to length ratio (aspect ratio). In addition, the manufacturing cost is significantly increased for attenuators having resistance imbalances. Because of the surface finish of commercially available substrates, changing the aspect ratios result in different surface resistance and further complicate the resistor manufacturing process for such high attenuation components. Further, it is difficult maintaining a desired input and output impedance match when resistance imbalances occur.

It should therefore be appreciated that there is a need for an attenuator that reduces resistance imbalances while maintaining a desired input and output impedance match. The present invention fulfills this need as well as others.

### SUMMARY OF THE INVENTION

An attenuator is provided which includes a first conductive path having a coupled line section and configured to receive a signal. The attenuator further provides a coupling section configured to attenuate the signal to produce an attenuated signal and positioned adjacent to the coupled line section of the first conductive path. A second conductive path is also provided having a coupled line section positioned adjacent to the coupling section and configured to carry, propagate or transmit the attenuated signal. The coupling section allows the signal to be coupled from the first conductive path to the second conductive path at the desired attenuation value. A first resistor is connected to the first conductive path and configured to dissipate power from the input signal and to provide termination at the system's characteristic impedance. A second resistor is connected to the second conductive path and configured to dissipate reflected power from the attenuated signal and to provide termination at the system's characteristic impedance.

Advantages of the present invention include providing an attenuator, which reduces resistance imbalances while maintaining a desired input and output impedance match.

Other features and advantages of the present invention should become apparent from the following description of the preferred embodiment, taken in conjunction with the accompanying drawings, which illustrate, by way of example, the principles of the present invention.

### BRIEF DESCRIPTION OF THE DRAWINGS

Embodiments of the present invention will now be described, by way of example only, with reference to the following drawings in which:

FIG. 1 is a schematic diagram of a prior art resistance “Pi” attenuator;

FIG. 2 is a schematic diagram of a prior art resistance “T” attenuator;

FIG. 3 is a schematic diagram of an attenuator having a coupling section and a plurality of resistors according to one embodiment of the present invention;

FIG. 4 is a perspective view of the attenuator of FIG. 3, fabricated on a substrate;

FIG. 5 is a top plan view of the attenuator of FIG. 4;

FIG. 6 is a bottom plan view of the attenuator of FIG. 4;

FIG. 7 is a perspective view of the attenuator of FIG. 4 mounted on a heat sink; and

FIG. 8 is a perspective view of the attenuator of FIG. 4 mounted on a base that is mounted on a heat sink.

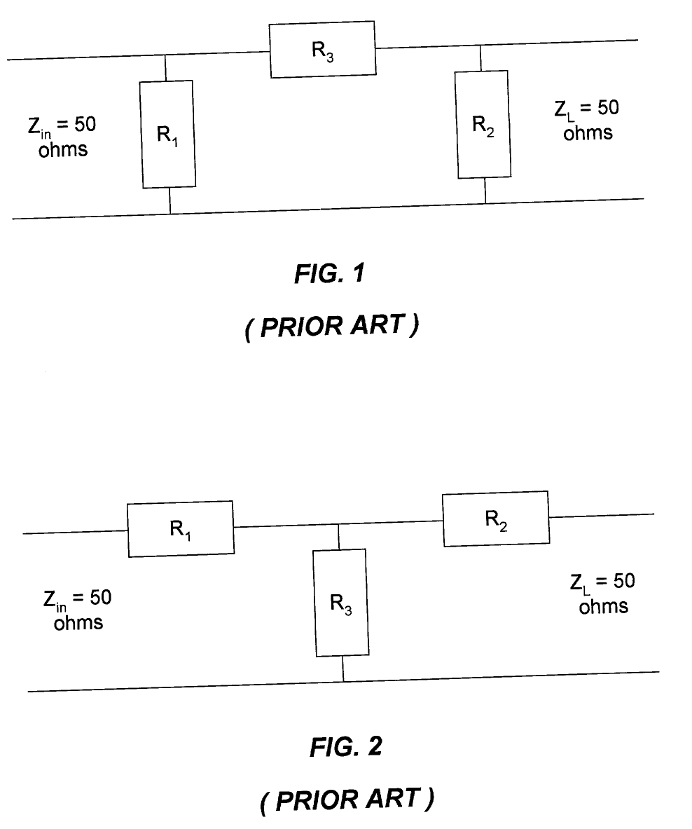

### DESCRIPTION OF THE PREFERRED EMBODIMENT

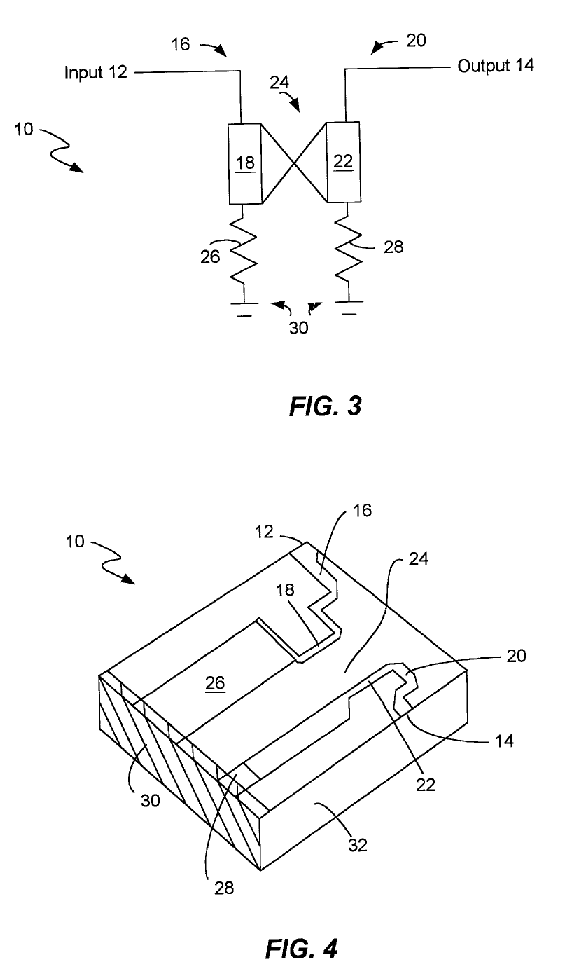

The term “attenuator” and “attenuator chip” may be used interchangeably throughout this description. With reference to the illustrative drawings, and particularly to FIG. 3, there is shown a schematic diagram of an attenuator 10 that reduces resistance imbalances while maintaining a desired input and output impedance match. The attenuator includes an input terminal 12, an output terminal 14, a first conductive path 16 having a coupled line section 18, a second conductive path 20 having a coupled line section 22, a coupling section 24, a first resistor 26, a second resistor 28, and a ground wrap 30.

FIG. 4 is a perspective view of the attenuator 10 of FIG. 3, fabricated on a substrate 32. A protective coating (not shown) made from a dielectric material may be applied to the attenuator to protect the attenuator from the environment, weather effects, etc. The attenuator is typically fabricated on or formed as part of the substrate, which is preferably made from a ceramic material (e.g., beryllium aluminum nitride, alumina oxide), a silicon material (e.g., diamond, boron nitride, glass or mica), or a common circuit board material, and has a length of approximately 0.5 inches, a width of approximately 0.5 inches, and a thickness of approximately 0.04 inches. The size of the attenuator is dependent on the input power and power dissipation of the attenuator. Other size attenuators can be utilized for similar and different applications without departing from the scope of the present invention.

The input terminal 12 is configured to receive an input signal and the output terminal 14 is configured to carry, propagate or transmit an attenuated signal, which is the resulting attenuated signal produced by coupling the input signal. The first and second conductive paths 16, 20 are also configured to receive, propagate, or transmit the input and attenuated signals. The input and output terminals may be connected to a transmission line, a wireless link, a cable, e.g., a coaxial cable or fiber optic cable, or other medium, or may be connected to the cable via flanges or tabs. Typically, an RF signal travels along the transmission line, is received at the input terminal, and travels from the first conductive path 16 to the second conductive path 20. In particular, the broadside coupling of coupled line sections 18, 22, allows the signal to propagate from the first conductive path to the second conductive path. That is, the signal is coupled across the coupling section 24, which is positioned between the coupled line section 18 of the first conductive path and the coupled line section 22 of the second conductive path.

During the signal propagation, some of the signal energy is dissipated as a form of heat energy by the resistor 26, e.g., load side resistor, and some of the input signal is transmitted through the coupling section 24 from coupled line section 18 to coupled line section 22. The desired attenuation is obtained by the length and separation distance of the coupled line sections 18, 22. In other words, the length and width of the coupling section 24 can be altered to achieve the desired attenuation. Typically, the load side resistor is isolated, i.e., a very small portion of coupled signal is dissipated by the termination side resistor; however, the termination side resistor dissipates the reflected signal from the output terminal. The attenuated signal splits between output terminal 14 and resistor 28, e.g., termination side resistor, thus further attenuating the attenuated signal. Since resistor 26 might dissipate a large portion of the input signal, the surface area of load side resistor 26 is larger than the termination side resistor 28. The current on each resistor travels to a ground conductor 34 through the ground wrap 30 (see also FIG. 6). Alternatively, if a bi-directional coupler is desired, the load and termination side resistors typically have approximately the same surface area.

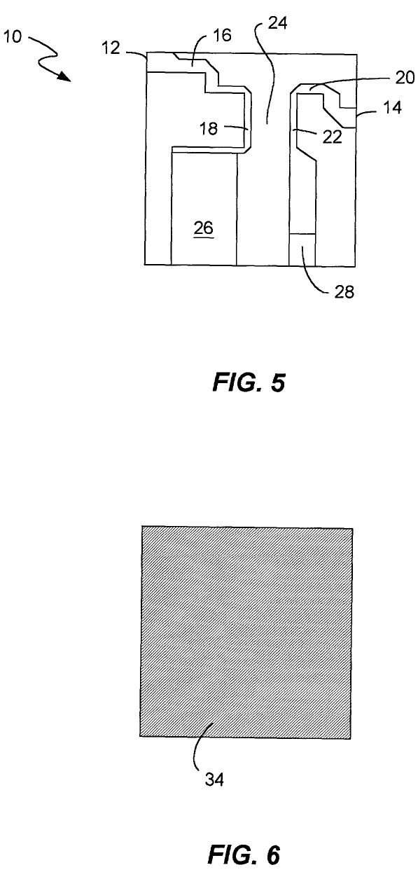

FIG. 5 is a top plan view of the attenuator 10 of FIG. 4. The first conductive path 16 is formed on or as part of the substrate 32 and is made from a metallic material such as gold, tin, copper, aluminum or silver. The first conductive path is connected at one end to the input terminal 12 and at the other end to the first resistor 26. In one embodiment, at the input terminal, the first conductive path has a width of approximately 0.05 inches. In the coupled line section 18, the first conductive path has a width of approximately 0.015 inches. When the signal reaches the coupled line section of the first conductive path, some of the signal is directed to the first resistor 26, which dissipates most of the signal energy by allowing the signal energy to flow to the ground conductor 34 (see also FIG. 6) through the first resistor 26 and the ground wrap 30. The ground wrap is a conductive material that provides a current path to the ground conductor.

The second conductive path 20 is formed on or as part of the substrate 32 and is made from a metallic material such as gold, tin, copper, aluminum or silver. The second conductive path is connected at one end to the output terminal 14 and at the other end to the second resistor 28. In one embodiment, at the output terminal, the second conductive path has a width of approximately 0.05 inches. In one embodiment, in the coupled line section 22, the second conductive path has a width of approximately 0.015 inches. When the signal reaches the coupled line section of the second conductive path, most of the attenuated signal travels to the output terminal 14 and a very small portion of the attenuated signal is reflected back and dissipated by the resistor 28, e.g., termination side resistor. Hence, the resistor 28 dissipates the power of the reflected attenuated signal.

Coupling section 24, which attenuates the signal, is the area or section between the coupled line section 18 of the first conductive path 16 and the coupled line section 22 of the second conductive path 24. In one embodiment, the coupling section has a spacing or width of approximately 0.082 inches, and a length of approximately 0.10 inches. Using these measurements, the attenuation produced by the attenuator is 30 dB at a frequency of 2.0 GHz. As the spacing between the coupled line section 18 and coupled line section 22 increases, the amount of attenuation obtained by the attenuator increases. One of ordinary skill in the art will be able to build an attenuator having a desired attenuation from the description of the present invention. The coupling section typically has an impedance of approximately 89 ohms for a 50 ohm system. The impedance of the coupling section can range from approximately 70 ohms to 100 ohms. The coupling section is typically made from an electrically non-conductive material. Preferably, the electrically non-conductive material is made from the same material as the substrate 32.

The first and second resistors 26, 28 are formed on or as part of the substrate 32 and are made from a resistive material such as nickel chrome, tantalum nitride, or resistive inks. The first and second resistors' impedance, e.g., 50 ohms, is typically matched to the impedance of the overall system. In one embodiment, the first resistor has a length of approximately 0.310 inches and a width of approximately 0.175 inches. The second resistor has a length of approximately 0.09 inches and a width of approximately 0.05 inches. Both resistors are electrically and mechanically connected to the ground wrap 30.

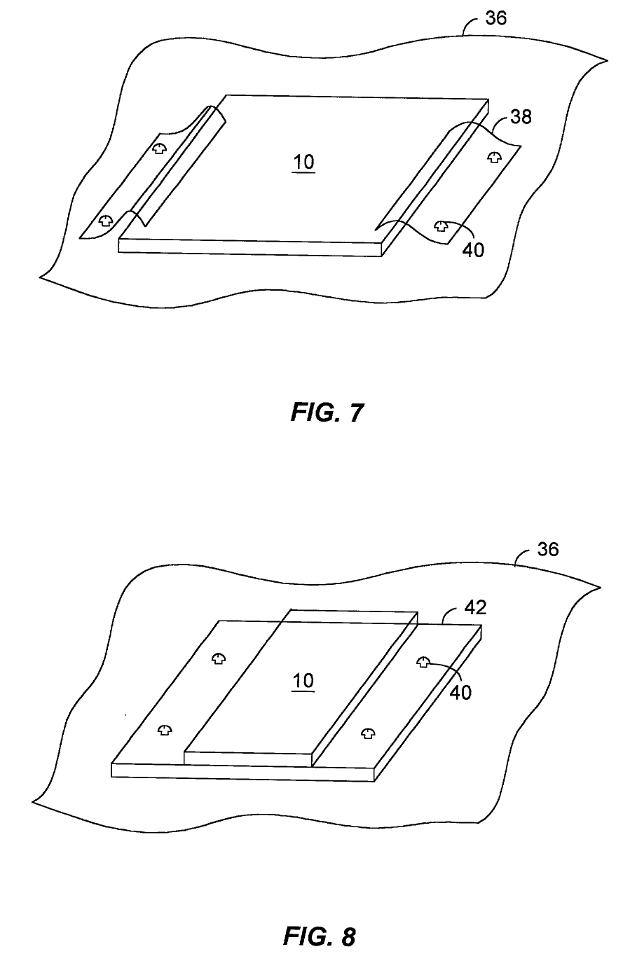

FIG. 6 is a bottom plan view of the attenuator 10 of FIG. 4. Preferably, the entire bottom portion of the attenuator is a ground conductor 34, which is electrically and mechanically connected to the ground wrap 30 (see also FIG. 4). The ground conductor is formed on or as part of the substrate 32 and is made from a conductive material such as gold, tin, copper, aluminum or silver. The ground conductor receives the signal energy from the ground wrap and is electrically and mechanically connected to a heat sink 36 (see FIGS. 7 and 8), which dissipates the signal energy as heat energy. Substrate 32 is attached to the heat sink either mechanically (see FIG. 7) or solder mounted through a base 42 through the ground conductor (see FIG. 8).

FIG. 7 is a perspective view of the attenuator 10 of FIG. 4 mounted on the heat sink 36. Preferably, the attenuator is mounted on the heat sink using mounts 38 and screws 40. The mechanical mounting normally uses two mechanical mounts or springs and screws, which hold or press the attenuator chip onto the heat sink. The pressure created by the mounts and the screws provides an electrical and heat dissipation contact on the heat sink. Alternatively, any mounting means can be used to mount the attenuator chip to the heat sink. The ground conductor 34 of the attenuator electrically and mechanically contacts the heat sink, which dissipates the signal as heat energy. The heat sink is preferably made from an electrically and thermally conductive material such as gold, tin, copper, aluminum, silver or other metal.

FIG. 8 is a perspective view of the attenuator 10 of FIG. 4 mounted on a base 42 that is mounted by screws 40 on the heat sink 36. The base is preferably made from an electrically and thermally conductive material such as gold, tin, copper, aluminum, silver or other metal. The attenuator may be soldered to the base. In solder mounting, the attenuator chip is solder attached to the base, which is attached onto the heat sink using the screws. Alternatively, the attenuator chip can be directly soldered to the heat sink.

The foregoing detailed description of the present invention is provided for the purposes of illustration and is not intended to be exhaustive or to limit the present invention to the precise embodiment disclosed. Accordingly, the scope of the present invention is defined by the following claims.

What is claimed is:

1. An attenuator comprising:
a first conductive path having a coupled line section, the first conductive path configured to receive a signal;
a coupling section configured to attenuate the signal to produce an attenuated signal and positioned adjacent to the coupled line section of the first conductive path;
a second conductive path having a coupled line section positioned adjacent to the coupling section and configured to transmit the attenuated signal;
a first resistor connected to the first conductive path and configured to dissipate power from the signal; and
a second resistor connected to the second conductive path and configured to terminate the second conductive path and dissipate reflected power from the attenuated signal.

2. The attenuator as defined in claim 1, further comprising a ground wrap connected to the first and second resistors.

3. The attenuator as defined in claim 2, further comprising a ground conductor connected to the ground wrap, the ground conductor configured to conduct current from the signal and the reflected attenuated signal.

4. The attenuator as defined in claim 2, further comprising a ground conductor connected to the ground wrap, the ground conductor configured to carry current to a heat sink, which dissipates power.

5. The attenuator as defined in claim 2, further comprising a heat sink connected to the ground wrap, which is configured to carry current and heat to the heat sink, which dissipates power.

6. The attenuator as defined in claim 1, further comprising a ground wrap configured to dissipate power from the signal and the attenuated signal.

7. The attenuator as defined in claim 1, wherein the first and second resistors have approximately the same resistance value.

8. The attenuator as defined in claim 1, wherein the first resistor has a surface area approximately equal to that of the second resistor for a bi-directional application.

9. The attenuator as defined in claim 1, wherein the first resistor has a larger surface area than the second resistor for a directional application.

10. The attenuator as defined in claim 1, wherein the first and second resistors are further configured to provide termination at the system's characteristic impedance.

11. The attenuator as defined in claim 1, wherein the coupling section has an impedance in the range of between approximately 70 ohms to 100 ohms for a 50 ohm system.

12. The attenuator as defined in claim 1, wherein the coupling section is made from an electrically non-conductive material.

13. An attenuator comprising:
an input terminal configured to receive a signal;
a coupling section configured to attenuate the signal to produce an attenuated signal;
an output terminal configured to carry the attenuated signal and to produce a reflected attenuated signal;
a first resistor coupled to the input terminal and configured to dissipate power from the signal; and
a second resistor coupled to the output terminal and configured to dissipate power from the reflected attenuated signal.

14. The attenuator as defined in claim 13, further comprising a first conductive path connecting the input terminal to the first resistor.

15. The attenuator as defined in claim 14, further comprising a second conductive path connecting the output terminal to the second resistor.

16. The attenuator as defined in claim 15, wherein the first and second conductive paths have a coupled line section.

17. The attenuator as defined in claim 13, wherein the coupling section has an impedance in the range of between approximately 70 ohms to 100 ohms for a 50 ohm system.

18. The attenuator as defined in claim 13, wherein the first and second resistors have approximately the same resistance value.

19. The attenuator as defined in claim 13, wherein the first resistor has a surface area approximately equal to that of the second resistor for a bi-directional application.

20. The attenuator as defined in claim 13, wherein the first resistor has a larger surface area than the second resistor for a directional application.

21. The attenuator as defined in claim 13, wherein the first and second resistors are further configured to provide termination at the system's characteristic impedance.

22. An attenuator comprising:
an input terminal configured to receive a signal;
means for attenuating the signal to produce an attenuated signal;
an output terminal configured to carry the attenuated signal;
a first resistor coupled to the input terminal and configured to dissipate power from the signal; and
a second resistor coupled to the output terminal and configured to dissipate reflected power from the attenuated signal and to provide termination.
